(19) United States
(12) Patent Application Publication
(10) Pub. No.: US 2026/0153132 A1
(43) Pub. Date: Jun. 4, 2026

(54) BRAKE SYSTEM WITH LOCKING DEVICE AND METHOD OF OPERATING A BRAKE SYSTEM

(71) Applicant: AKEBONO BRAKE INDUSTRY CO., LTD., Chuo-ku, Tokyo (JP)

(72) Inventors: George Ritter, Pleasant Ridge, MI (US); Phil Nathanael Jedele, Ypsilanti, MI (US)

(21) Appl. No.: 18/719,894

(22) PCT Filed: May 23, 2023
(86) PCT No.: PCT/IB2023/055297

§ 371 Date: Jun. 14, 2024

Related U.S. Application Data
(60) Provisional application No. 63/346,490, filed on May 27, 2022.

(51) Int. Cl. F16D 55/226; F16D 65/18; F16D 121/24; F16D 125/40; F16D 125/50

(52) U.S. Cl. CPC F16D 55/226; F16D 65/183; F16D 2121/24; F16D 2125/40; F16D 2125/50

(57) ABSTRACT

A brake system (100) that includes a brake caliper (102); a brake piston (118) supported by the brake caliper; a brake pad (104, 106) supported by the brake caliper; a rotary to linear stage mechanism (126); a motor (136) configured to drive the rotary to linear stage mechanism to move the brake piston and the brake pad against a brake rotor to generate a clamping force; and a locking device (146) configured to maintain a position of the rotary to linear stage mechanism after the clamping force has been created, wherein the locking device comprises a bistable solenoid (148). The motor is located on one side of the rotary to linear stage mechanism and the locking device is located on another side of the rotary to linear stage mechanism.

### CROSS-REFERENCE TO RELATED APPLICATIONS

This application claims the benefit of U.S. 63/346,490 filed May 27, 2022, the entirety of which is hereby incorporated by reference herein for all purposes.

### FIELD

These teachings relate to a brake system and to a method of operating a brake system.

### BACKGROUND

Many vehicles have one or more brake systems to create a clamping force to slow, stop, and/or maintain the vehicle in a stopped or parked position.

It would be desirable to improve the current state of the art by having an improved brake system and/or an improved method of operating a brake system. For example, it may be desirable to have a brake system and/or a method of operating a brake system that is configured to reduce or minimize chances of prematurely releasing the clamping force. It may be desirable to have a brake system and/or a method that includes improvements over the state in the art to ensure or improve changes of the clamping force being quickly and efficiently created.

### SUMMARY

A brake system is disclosed. The brake system may be a system that utilizes one or more motors and one or more actuators to generate a clamping force during a braking event. The braking event may be a service brake apply, a parking brake apply, or both. The brake system may operate without hydraulic fluid to create the clamping force. The brake system may be an electromechanical brake system.

A method of operating a brake system is disclosed. The method may be used for operating a brake system, which may be the brake system according to these teachings. However, in some configurations, the method disclosed herein may be used for operating a brake system that is a variation of the brake system disclosed herein. In some configurations, the method disclosed herein may be used with other brake systems, which are not exactly illustrated and/or described herein.

The brake system and/or method disclosed herein may advantageously improve braking performance by improving the creation of a clamping force, improve maintaining a clamping force after creation, and/or improve releasing the clamping force. The brake system and/or method includes improvements in maintaining the clamping force to reduce or minimize chances of prematurely releasing the clamping force. The brake system and/or method includes an improvement in pre-charging to ensure the clamping force can be quickly and efficiently created.

### BRIEF DESCRIPTION OF THE DRAWINGS

FIG. 1 is a perspective view of a brake system and a brake rotor.

FIG. 2 is a perspective view of a brake system.

FIG. 3 is a cross-sectional view of the brake system of FIG. 2, taken along line 3-3.

FIG. 4 is a perspective view of an actuator and rotary to linear stage mechanism.

FIG. 5 is an exploded perspective view of FIG. 4.

FIG. 6A is a perspective view of a locking device.

FIG. 6B is an explosion perspective view of the locking device of FIG. 6A.

FIG. 6C is an explosion, perspective view of the locking device of FIG. 6A.

FIG. 7A is a side view of the locking device, in a disengaged position.

FIG. 7B is a side view of the locking device, in an engaged position.

FIG. 8A is a cross sectional view of an exemplary latching solenoid in an un-latched position.

FIG. 8B is a cross sectional view of an exemplary latching solenoid in a latched position.

FIG. 9 shows a field-oriented control (FOC) method of the motor.

FIG. 10 shows a speed-based control method of the motor.

FIG. 11 shows a position-based control method of the motor.

FIG. 12 shows a motor force controller with force feedback and feedforward components.

FIG. 13 shows a motor force controller with degraded force estimation.

FIG. 14 shows method steps associated with the brake system entering a pre-charge state.

FIG. 15 shows method step associated with operation of the brake system during a service brake operation.

FIG. 16 shows method steps associated with generating a clamping force or applying the parking brake.

FIG. 17 shows method steps associated with releasing the clamping force generated in FIG. 16.

### DETAILED DESCRIPTION

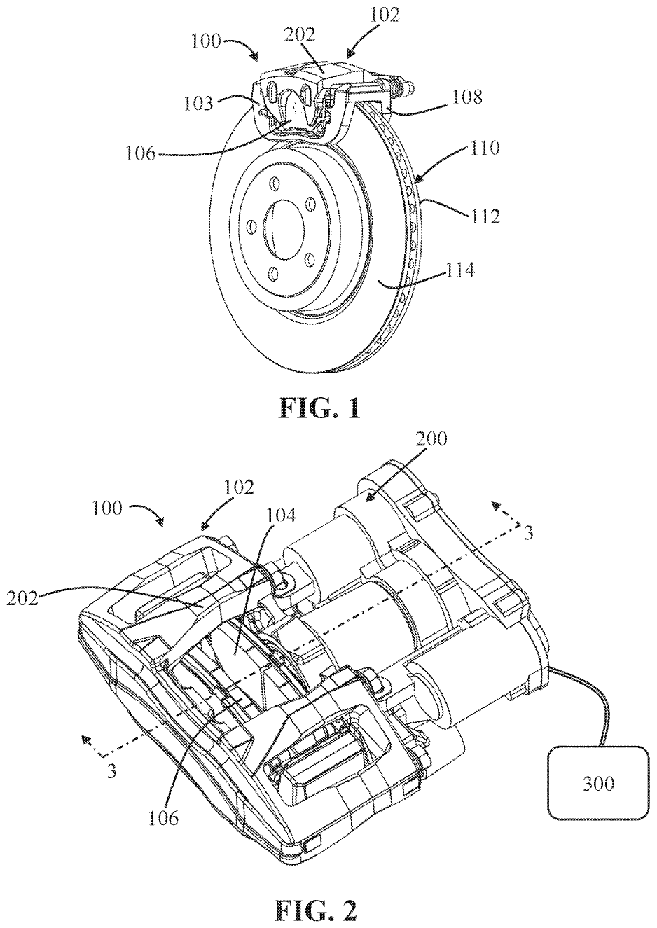

FIGS. 1, 2, and 3 illustrate a brake system 100. The brake system 100 includes a brake caliper 102 that supports an inboard brake pad 104 and an outboard brake pad 106. The brake caliper 102 may include a support bracket 103 that supports the brake pads 104, 106. In some configurations, the support bracket 103 may be considered part of the brake caliper 102 or in other configurations, the support bracket 103 may be a component attached to the brake caliper 102. The brake system 100 includes a support bracket 108 for attaching the brake system 100 and/or the brake caliper 102 to the vehicle, such as to a steering knuckle of the vehicle.

The brake system 100 is shown relative to a brake rotor 110 in FIG. 1. The brake rotor 110 has an inboard side 112 and an opposing outboard side 114. After the brake system 100 is attached to the vehicle, the friction material of the inboard brake pad 104 faces the inboard side 112 of the brake rotor 110 and the friction material of the outboard brake pad 106 faces the outboard side 114 of the brake rotor 110.

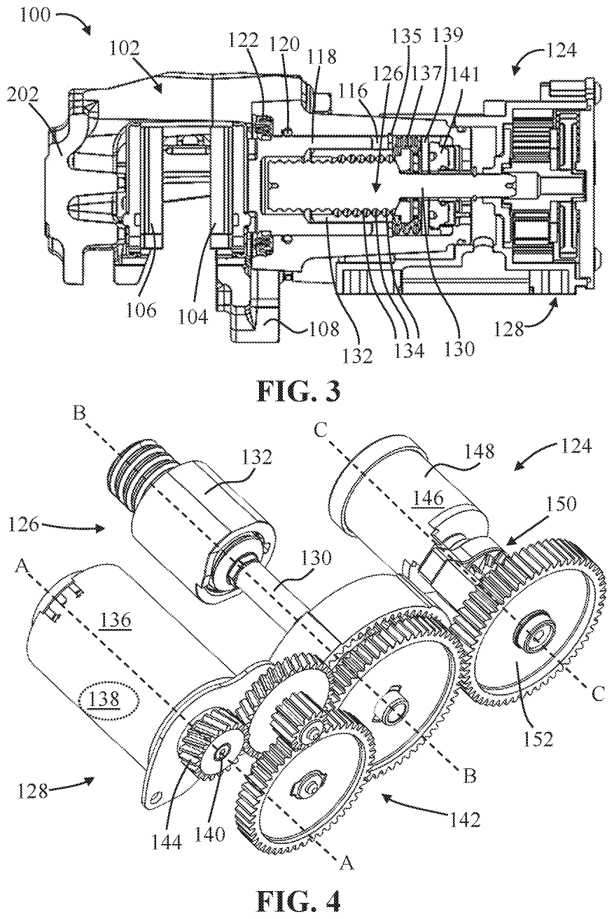

With specific reference to FIG. 3, the brake caliper 102 includes one or more cylinders or bores 116. A brake piston 118 is supported in each cylinder or bore 116. High performance vehicles and/or larger vehicles, like pickup trucks and utility vehicles, may have a brake caliper 102 with more than one bore 116 and thus more than one brake piston 118 in order to create a sufficient clamping force to slow, stop, and/or prevent movement of the vehicle. On the other hand, light duty vehicles may have a brake caliper 102 with only one bore 116 and thus only one brake piston 118, which may be sufficient to create a clamping force to slow, stop, and/or prevent movement of the vehicle.

The brake system 100 may have one or more bores 116 and corresponding pistons 118 located on one side of the brake rotor 110, such as on the inboard side or on the outboard side. In other configurations, the brake system 100 may have one or more bores 116 and corresponding pistons 118 located on both sides of the brake rotor 110 (i.e., on the inboard side and outboard side).

A piston seal 120 and dust boot 122 may be provided between an outer surface of the brake piston 118 and the inner surface or diameter of the bore 116. The piston seal 120 may be a flexible or elastic material or member that assists in returning or rolling the brake piston 118 back into the bore 116 after a brake apply (to release the brake apply and/or the clamping force). The dust boot 122 may be a flexible or elastic material or member that forms a seal around the brake piston 118. The dust boot 122 may restrict or prevent debris and/or fluid from entering the gap between the bore 116 and the brake piston 118.

Referring now to FIG. 4, the brake system 100 may include an actuator 124. The actuator 124 may be used to move the rotary to linear stage mechanism 126, which may in turn move the one or more brake pistons 118 and brake pads to create and/or release the clamping force. Some or all of the elements of the actuator 124 may be contained in a housing 200 (FIG. 2). The housing 200 can be attached to the brake caliper 102. Attaching the housing 200 to the caliper 102 may allow for the actuator 124 to be assembled in a separate line or facility and then assembled or attached to the caliper 102 in another line or facility. This may allow the brake system 100 to be easily serviced if a repair or maintenance of the actuator 124 or brake system 100 is required. This may allow one supplier or manufacturer to build or assemble the actuator 124 and then provide the actuator 124 in the housing 200 to a customer for assembly to the brake caliper 102, or vice versa. The housing 200 may be attached to the caliper 102 via one or more fasteners (screws, bolts, welding, etc.) In some configurations, the housing 200 may be an integral component of the brake caliper 102 or permanently secured thereto via welding or other attachment methods. In some configurations, a portion of the housing 200 may be secured to or integrated into the caliper 102 but may include a door or other access region that can be removed or opened to access the internal components of the brake system 100 or actuator 124 for inspection and/or service. During assembly of the brake system 100, the actuator 124 may be contained in the housing 200 and then connected to the rotary to linear stage mechanism 126, which may be already installed in the brake caliper 102.

The rotary to linear stage mechanism 126 may be an assembly or mechanism located downstream of the actuator 124. However, in some configurations, the rotary to linear stage mechanism 126 may be part of the actuator 124 (and may optionally be contained in the housing 200).

The rotary to linear stage mechanism 126 is a mechanism that is configured to convert a rotary input torque into a linear output force. The rotary input torque may be supplied to the rotary to linear stage mechanism 126 by the actuator 124 and/or by one or more motors 136. The linear output force may be used to move the brake piston(s) 118 and/or structure of the brake system and thus the inboard brake pad 104 towards and ultimately against the inboard side 112 of the brake rotor 110 to create the clamping force. The rotary to linear stage mechanism 126 may be a high efficiency device such as a ball nut assembly, a ball ramp assembly, a roller screw assembly. In some configurations, the rotary to linear stage mechanism 126 may be a low efficiency device such as a lead screw and nut assembly. Of course, depending on the arrangement of the brake system 100, the rotary to linear state mechanism 126 may be arranged to (additionally or alternately) move brake pistons located at the outboard side of the brake rotor, which would then move the outboard brake pad against the brake rotor to create the clamping force.

In the illustrated example of FIGS. 3 and 4, the rotary to linear stage mechanism 126 comprises a spindle 130 and a nut 132. The illustrated rotary to linear stage mechanism 126 is a ball nut assembly. A plurality of balls 134 may be arranged in tracks, grooves, or slots defined between the spindle 130 and the nut 132.

With continued reference to FIG. 3, the brake system 100 may include a retainer or clip 135, a retainer or spring 137, a thrust bearing 139, and a force sensor or transducer 141. The force sensor or transducer 141 may provide a force feedback (or feedback force) to a controller during the brake apply and/or a brake release (during a service brake apply or release and/or a parking brake apply or release), discussed further below in the method of operating the brake system. That is, the force sensor 141 may detect and transmit information to the controller indicative of how much clamping force (if any) is present, based on how much force the nut is applying on the brake piston, which in turn applies a force on the brake pad, which in turn applies a force on the brake rotor to generate the clamping force. While the force sensor is illustrated as sandwiched between the thrust bearing 139 and a back of the bore housing the brake piston, the force sensor 141 may be arranged in any location of the brake system 100, such as between the nut and the brake piston, between the brake piston and the brake pad, between the brake pad and the brake rotor. There may be more than one force sensor 141 in the brake system 100, to improve accuracy of the force measurements and/or to provide a backup or safety sensor.

The actuator 124 may include a motor gear unit 128. The actuator 124 and/or the motor gear unit 128 may include one or more motors 136. The motor 136 may be any device that is configured to generate and supply torque to the motor gear unit 128 and/or to the actuator 124. The motor 136 may be a brushless motor. The motor 136 may have an integrated rotary position sensor 138. Alternatively, the brake system 100 may have the rotary position sensor 138 that is separate from the motor 136. The rotary position sensor 138 is configured to detect and transmit a rotary or angular position of an output shaft 140 or output gear 144 of the motor 136. In some configurations, the position sensor 138 may instead be configured to determine a position of the brake piston, the brake pad, the nut, the spindle, the rotary to linear stage mechanism, and/or one or more of the gears of the brake system 100. This rotary position sensor 138 can detect the rotary or angular position of the output gear 144 of the motor 136 and/or the rotary or angular position of the spindle 130, which can be used to determine the axial position of the piston 118. By understanding the axial position of the piston 118, it can be determined how much clamping force is being generated (if any at all) depending on the axial position of the nut, brake piston, and thus brake pad relative to the brake rotor.

The actuator 124 and/or the motor gear unit 128 may include one or more gears 142. The one or more gears 142 may be arranged between the motor 136 and the rotary to linear stage mechanism 126. The one or more gears 142 may be a gear train that is configured to transfer or supply the torque from the motor 136 to the rotary to linear stage mechanism 126. More specifically, the one or more gears 142 may transfer the torque from the motor 136 to the spindle 130. The one or more gears 142 may function to increase or decrease or simply transmit without increasing or decreasing the torque output from the motor 136 before the torque is supplied to the rotary to linear stage mechanism 126 or spindle 130. In other words, the one or more gears 142 or gear train may be tuned to a specific gear ratio for specific applications. The one or more gears 142 may function to increase or decrease the speed and/or torque output from the motor 136 before the torque is supplied to the rotary to linear stage mechanism 126 or spindle 130. The one or more gears 142 may function to maintain the speed and/or torque output from the motor 136 before the torque is supplied to the rotary to linear stage mechanism 126 or spindle 130.

The brake system 102, the actuator 124, and/or the motor gear unit 128 may include one or more locking devices 146. The locking device 146 may be a device configured to maintain the clamping force after a brake apply is created (service brake and/or parking brake). The locking device 146 may be a device configured to lock the rotary to linear stage mechanism 126 to prevent the spindle 130 and nut 132 from moving or back driving and/or prematurely or unintentionally releasing the clamping force. The locking device 146 may be a device configured to restrict or prevent the brake piston 118 from rolling back after the clamping force has been achieved. The locking device 146 may be a device that maintains the clamping force and/or a position of the brake pads against the brake rotor after the clamping force has been created. The locking device 146 may be a device that maintains an angular or rotary position of the output shaft or gear of the motor. The locking device 146 may be a device that maintains an angular or rotational position of the one or more gears 142 in the gear train or motor gear unit.

In some configurations, one or more of the locking devices 146 may be configured to lock or maintain the brake system from generating clamping force. In other words, the locking device 146 may be configured to lock or maintain a position of the motor to prevent the motor and/or the rotary to linear stage mechanism from prematurely engaging or moving the brake piston. The one or more locking devices may be configured to prevent premature engagement or creation of the clamping force.

The locking device 146 may include one or more solenoids 148, one or more clutch assemblies 150, and one or more gears, such as output gear 152.

As can be appreciated from viewing FIG. 4, the motor 136 is arranged on one side of the rotary to linear stage mechanism 126 (and thus on one side of the brake piston and bore in the brake caliper) and the locking device 146 is arranged on the other side of the rotary to linear stage mechanism 26 (and thus on the other side of the brake piston and bore in the brake caliper). This arrangement advantageously allows the weight or mass of the motor 136 and locking device 146 to be evenly balanced and/or distributed on the brake caliper 102 and pins, instead of being overloaded on one side and/or one pin if the motor 136 and locking device 146 were arranged on the same side of the brake caliper 102. This arrangement also allows for different gear ratios (i.e., different number, type, and/or size of gears 142) between the motor 136 and the rotary to linear stage mechanism 126 and the locking device 146 and the rotary to linear stage mechanism 126. Having different gear ratios may allow for independent tuning of the rotational variation and loading on the locking device 146 during a parking brake apply, without affecting the motor 136 to the rotary to linear stage mechanism 126 gear ratio.

As can be appreciated from viewing FIG. 4, the motor output 140 of the motor 136 is configured to rotate about axis A, the spindle 130 is configured to rotate about axis B and the nut 132 is configured to move along axis B, and the mating member 190 of the locking device 146 and gear 152 are configured to rotate about axis C. Two or more of the axis A, B, C (but preferably all three of the axis A, B, C) are generally parallel to one another. Moreover, the spacing between axis A and B may be substantially the same as the spacing between axis B and C. This equal spacing between adjacent axis A, B and B, C advantageously provides an equal mass distribution of the elements of the brake system 100 on the brake caliper 102 to improve performance of the brake system 100. However, in some configurations, the spacing between axis A and B may be less than or greater than the spacing between axis B and C. It should be noted that the position of the motor 136 may be exchanged with the position of the locking device 146 (i.e., the motor 136 may be located where the locking device 146 is located and the locking device 146 moved to where the motor 136 is currently located). In some configurations, the motor 136 may be arranged on top of or next to the locking device 146, or vice versa. In some configurations, the locking device 146 may be integrated with the motor 136 into a single device.

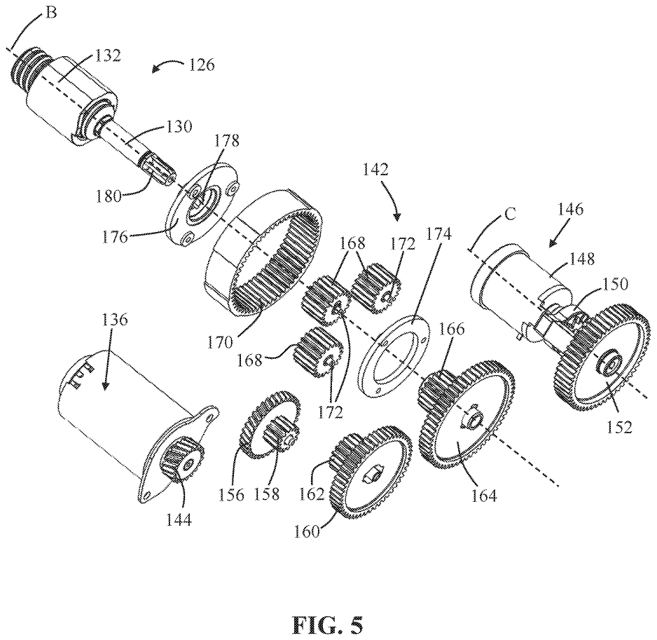

To initiate a brake apply or application during a service brake apply and/or a parking brake apply, one or more signals may be sent or transmitted to the brake system 100, the motor 136, the actuator 124 or a combination thereof. The signal may be sent by a controller 300 (FIG. 2) that is operable to control the motor 136. The controller 300 may be part of the brake system 100, the vehicle, or both. The one or more signals may instruct the motor 136 to turn ON and/or to begin generating torque. The torque from the motor 136 is transferred to the rotary to linear stage mechanism 126 via the one or more gears 142. More specifically, referring to FIG. 5, torque from the motor 136 is transferred to gear 156 via a meshing engagement of motor output gear 144 and gear 156, which causes gear 156 and gear 158 to rotate. Gear 158 may be rotationally fixed to gear 156, meaning when one of the gears is caused to rotate, the other gear also rotates. Gear 158 engages gear 160, which causes gear 160 and gear 162 to rotate. Gear 160 and 162 may be rotationally fixed, meaning when one of the gears is caused to rotate, the other gear also rotates. Gear 162 engages gear 164 and causes gear 164 and sun gear 166 to rotate. The sun gear 166 is surrounded by a plurality of planet gears 168 that are arranged inside an internal gear 170 having a toothed profile in its inner periphery. The planet gears 168 are arranged on respective axles 172, that are supported between carriers or plates 174, 176. Rotation of the sun gear 166 causes the planet gears 168 spin about their respective axles 172 and also rotate within the internal gear 170 about axis B, causing the carriers 174, 176 to rotate about axis B. Carrier 176 comprises an engaging portion 178 that is configured to engage a corresponding engaging portion 180 of the spindle 130. Rotation of the carrier 174 causes the spindle 130 to rotate about the longitudinal axis B. Rotation of the spindle 130 about axis B causes the nut 132 to translate or move in a linear direction along a length of the spindle 130 and/or along a length of the longitudinal axis B of the spindle 130. The nut 132 is moved along the spindle 130 until any gap between the nut and the brake piston is taken up and the nut 132 contacts the brake piston 118 and then pushes the brake piston 118 and then the inner brake pad 104 against the inboard side 112 of the brake rotor 110. In a sliding brake system like the one in the illustrated figures, a reaction force is then generated, which causes the bridge and fingers 202 to slide on the slide pins and pull the outboard brake pad 106 against the outboard side 114 of the brake rotor 110. The contacting of the friction material of the brake pads 104, 106 against the brake rotor 110 generates friction, which generates the torque to slow, stop, or prevent movement of the brake rotor 110 and thus the road wheel. In an opposed or fixed brake system that does not include a moving or sliding bridge, any brake pistons located on the opposite side of the brake rotor may be engaged or moved with a similar rotary to linear stage mechanism, like the one illustrated and described herein. One or more of the aforementioned gears may be removed or duplicated. For example, a non-limiting example of this is that gear 144 may engage gear 162.

The gears 166, 168, 170 and carriers 174, 176 may form a planetary gear system. The planetary gear system may function to increase torque or decrease torque or keep a torque output from the motor 136 constant. The planetary gear system may function to increase the output speed of the motor 136 or reduce the output speed of the motor 136 or keep the output speed of the motor 136 constant. The planetary gear system may be tuned to change the gear ratio to ensure a sufficient torque is supplied to the rotary to linear stage mechanism. In some configurations, the planetary gear system may be eliminated. In a configuration where gears are eliminated, the motor output 144 may directly drive the rotary to linear stage mechanism 126. In some configurations, one or more gears may be added to the gears 142 illustrated and/or disclosed herein. In some configurations, one or more gears 142 illustrated and/or disclosed herein may be rearranged, repositioned, or substituted with other gears or mechanism for transferring torque from the motor 136 to the rotary to linear stage mechanism 126, brake piston, and/or brake pad.

With continued reference to FIG. 5, the brake system 100 and/or the actuator 124 may comprise a locking device 146. The locking device 146 may be part of the brake system 100 or the locking device 146 may be part of the actuator 124, or the locking device 146 may be an independent device that is neither part of the brake system 100 or the actuator 124 but is assembled onto the system 100 as an independent component. The locking device 146 may be configured to lock the actuator 124 to restrict or prevent the rotary to linear mechanism 126 and/or the motor and/or the brake piston 118 from rolling back or back driving after the clamping force has been created after a service brake application, a parking brake application, or both. The locking device 146 may include a solenoid 148, a clutch assembly 150, and a locking device output gear 152. The locking device output gear 152 meshingly engages gear 164. Meshingly engages means the teeth of one gear engage the teeth or sockets between teeth of another gear. Other ways of engagement may also be considered including intermediate gears, belts, chains, or tooth-less gears that frictionally engage one another.

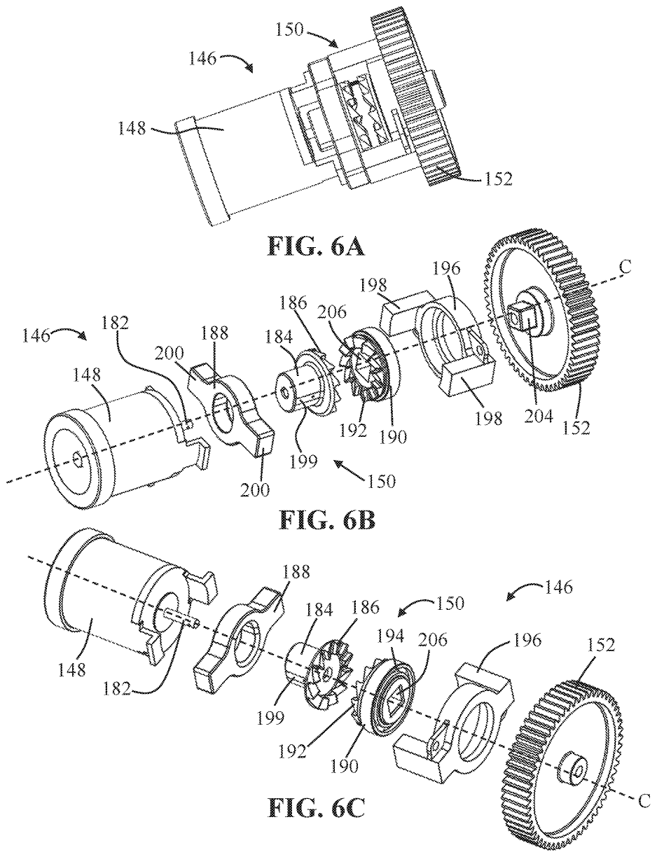

FIGS. 6A, 6B, and 6C illustrate the locking device 146. The locking device 146 may include a solenoid 148, a clutch assembly 150, and a locking device output gear 152.

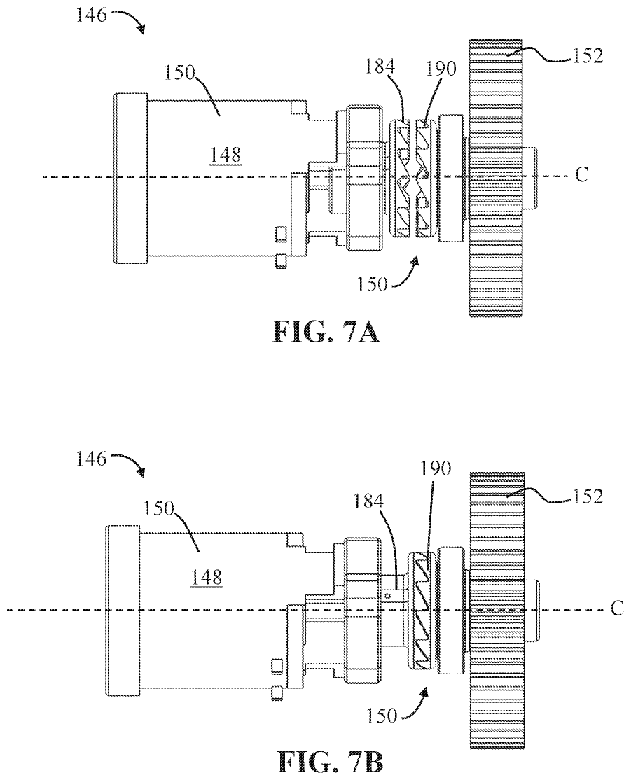

The solenoid 148 may be any solenoid, such as a bi-stable solenoid. A bi-stable solenoid is an electromechanical magnet with a linear direction of motion in which a moveable member 182 or piston or plunger is moved between a retracted, unlocked, or disengaged position (FIG. 7A) and an extended, locked, or engaged position (FIG. 7B). As shown in FIG. 5, the axis C may be parallel to axis B.

The moveable member 182 or piston of the locking device 146 or solenoid 148 is connected to an engaging member 184 that includes teeth 186. The engaging member 184 is supported in a bracket 188 or yoke. The engaging member 184 has an anti-rotation feature 199 that cooperates with a corresponding or mating anti-rotation feature in the bracket 188 or yoke to restrict or prevent the engaging member 184 from rotating or spinning about the longitudinal axis C of the locking device 146. The anti-rotation feature 199 may be any suitable feature, such as one or more pins, notches, flat or planar features, projections, set screws, depressions, keyed features, etc.

The locking device 146 comprises a mating member 190. The mating member 190 may be a dog with cogs or teeth 192 that are configured to engage the cogs or teeth 186 of the engaging member 184 when the moveable member 182 and engaging member 184 are moved towards the mating member 190 along the longitudinal axis C. After the teeth 186, 192 engage one another (i.e., a tooth fits into an opposing socket defined on the other member, a socket being defined between adjacent teeth), the locking device 146 may be locked.

The mating member 190 is or includes one or more bearings 194. The bearing 194 allows the mating member 190 to rotate or spin about the longitudinal axis C. The rotation of the mating member 190 allows the locking device 146 to remain locked or engaged (i.e., the teeth 186, 192 of the engaging member 184 and the mating member 190 remain engaged), while the clamping force is adjusted during a re-clamp procedure for example.

The mating member 190 is supported in an opening in a bracket 196. The opening is sized to accommodate the mating member 190 and bearing 194 and allow the mating member 190 to rotate about the axis C within the bracket 196. The bracket 196 is U-shaped and has arms 198 that are configured to engage corresponding arms 200 on the bracket 188 supporting the moveable member 182.

The locking device output gear 152 includes an engaging feature 204 that is configured to engaging a mating engaging feature 206 defined in the mating member 190. This engagement provides for the mating member 190 to rotate about the longitudinal axis C when the output gear 152 is rotated about the longitudinal axis C, which may occur when the clamping force is adjusted or increased.

After the clamping force is created, a signal may be sent from a controller to the locking device 146 to lock the brake system 100 to maintain the clamping force. The signal may be sent by the controller 300 (FIG. 2) that is operable to control one or both of the motor 136 and the solenoid 148 of the locking device 146. Preferably, the electronic control unit 300 is configured to independently control the motor 136 and the solenoid 148.

FIG. 7A illustrates the locking device 146 in the unlocked or disengaged position and FIG. 7B illustrates the locking device in the locked or engaged position. For purposes of clarity, the brackets 188, 196 are hidden in these figures.

Referring to FIGS. 7A and 7B, the one or more signals from the controller sent to the locking device 146 cause the moveable member or plunger 182 and thus the engaging member 184 to move axially along the axis C until the teeth 186 of the engaging member 184 engage or mesh with the sockets defined between adjacent teeth 192 of the mating member or dog 190 (moves from position in FIG. 7A to position in FIG. 7B). The slope of the walls of the teeth 186, 192 are steep enough to restrict or prevent the mating member 190 and the gear 152 from rotating in a release direction (For example, see the nearly vertical slope on the teeth 184, 190 in FIGS. 7A and 7B). Once engaged, the locking device output gear 152 is restricted or prevented from rotating about the axis C in a release direction due to its engagement with the mating member 190 via the engaging members 204, 206 (FIG. 6B). As was discussed above, the gear 152 is in meshing engagement with gear 164, which thus restricts or prevents or jams gear 164 from rotating about the axis B (FIG. 5). Because gear 164 is restricted from rotating about axis B, the rotary to linear stage mechanism 126 is locked and restricted from rotating about axis B, which thus prevents the brake piston 118 from rolling back, which maintains the brake pad 104 in contact with the brake rotor 110. Accordingly, the motor can be turned OFF or cease generating torque and the locking device 146 will maintain a position of the actuator and thus the clamp force.

In case a re-clamp is necessary, to adjust or increase the previously generated clamp force, one or more corresponding signals may be sent by the electronic control unit 300 to the actuator 124, motor 136, and/or driving portion 154, which will cause the motor 136 to generate and transfer torque to the linear to rotary stage mechanism 126 as was discussed above. The locking device 146 may remain locked or engaged during this time (remain in the position illustrated in FIG. 7B). However, due to the engagement of the locking device output gear 152 with the gear 164, when the gear 164 is rotated in the apply direction by the motor 136, the gear 152 and thus the mating member 190 may rotate in the apply direction about axis C. The low angled slopes of the mating teeth 186, 190 allow for the gear 152 and mating member 190 to rotate about axis C in the apply direction while the engaging member 184 remains fixed and does not rotate. In other words, the mating member 190 can be incrementally rotated or clocked in the apply direction by having the teeth 192 slide on the ramps into the next position on teeth 186 or socket of the engaging member 184 without releasing the clamping force.

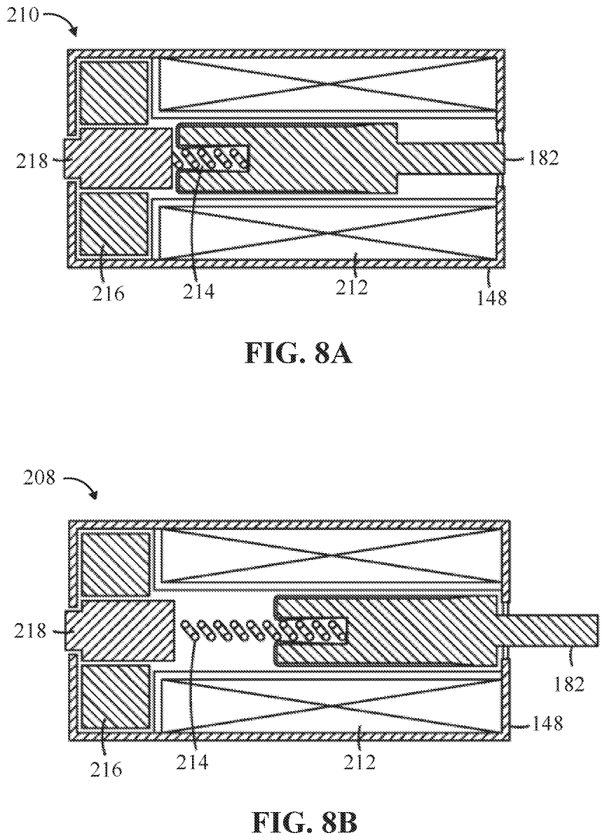

FIGS. 8A and 8B are cross sectional views of an exemplary solenoid 148. The solenoid 148 is a latching solenoid. The solenoid in FIG. 8A is in an un-latched position 210. The solenoid 148 in FIG. 8B is in a latched position 208.

The solenoid 148 may include the moveable member or plunger 182, a coil 212, a spring 214, a permanent magnet 216, and a pole 218. The moveable member or plunger 182 is connected to the engaging member 184 (See FIGS. 6B-6C and 7A-7B).

With additional reference back to FIGS. 6B-6C and 7A-7B, in the latched position 208 (FIG. 8B), the moveable member or plunger 182 is in an extended position, such that the engaging member 184 or teeth 186 thereof are in engagement with the teeth 192 of the mating member or dog 190. That is, the teeth 186 of the engagement member 184 fit between or are positioned between the teeth 192 of the mating member. The spring 214 provides the necessary biasing force to push or bias the plunger 182 in the extended position so that the engaging member 184 and teeth 186 remain engaged with/against the teeth 192 (or more specifically between the teeth 192) of the mating member or dog 190. During a re-clamp operation, the plunger 182 will slightly retract and compress the spring 214 as the teeth 186 of the engaging member 184 ride up and traverse the ramp profile of the teeth 192 of the mating member or dog 190. The spring 214 will then un-compress and bias the plunger 182 further into the extended position illustrated in FIG. 8B after the ramp profile of the teeth 192 of the mating member or dog 190 are traversed by the teeth 186 of the engaging member 184.

To move from the latched position 208 in FIG. 8B to the un-latched position 210 in FIG. 8A to release the locking member, the coil 212 is energized (via one or more signals from the controller 300) and the plunger 182 is moved axially against the spring 214, causing the spring 214 to compress, until the plunger 182 latches with the pole 218. During this energization phase, the total magnetic force is amplified as a sum of both the permanent magnet 216 and electromagnetic effects. Once in the un-latched state 210, the coil 212 is de-energized and the latching force is maintained by the permanent magnet 216 alone.

To latch from the un-latched state 210, the coil 212 is energized with a reverse polarity, which degrades the magnetic force until the spring 214 overcomes the magnetic latching force and then moves or biases or transitions the plunger 182 forward to the latched position 208 in FIG. 8B, as described above. Once in the latched state 208 the coil 212 is deenergized and the latching force is maintained by the spring force from the spring 214 alone.

The electrical control until 300 includes the necessary hardware to control the coil 212 polarity and therefore the brake engagement/disengagement.

The brake system 100 can operated and/or controlled with an electronic control unit 300. The electronic control unit 300 may be part of the vehicle, the brake system 100 or both. The controller 300 is in electrical communication with the brake system 100 and is operable to control both of the motor 136 and the solenoid 148 of the locking device 146. Preferably, the electronic control unit 300 is configured to independently control the motor 136 and the solenoid 148.

When a clamping force is to be applied (during a service brake operation and/or a parking brake operation) to slow, stop, or prevent movement of a road wheel of a vehicle one or more of the aforementioned or following method steps may be performed. It is understood that any method step disclosed herein may be omitted, duplicated, combined with another method step, or rearranged in a different sequence.

The method may include a step of measuring an absolute rotary or angular position of the motor 136 or motor output shaft or gear. The absolute initial position of the motor 136 or output shaft 140 or motor output 144 may be measured or determined by the rotary position sensor 138 or any other sensor of the brake system 100 or vehicle. In some configurations, a rotary to angular position of the spindle may be measured or determined with a sensor measuring the same.

The method may include a step of changing or incrementing the absolute initial position of the motor 136 or output shaft 140 or motor output 144 by means of a rotary encoder count for precise displacement measurements from the absolute initial position. This may eliminate the need for having an initialization routine to determine the correct commutation in case of an incremental encoder. The position sensor 138 may also include redundant measurements of both the absolute position of the motor 136 or shaft 140 or output gear 144 and incremental encoder signal for determination of feedback reliability.

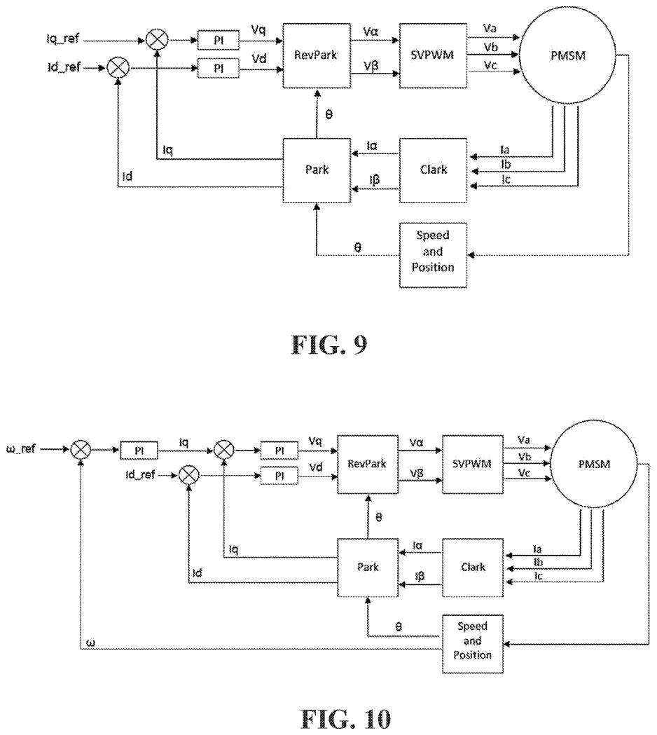

The brake system 100 may be controlled with a current-based control, via current from a power source, such as a battery, motor, engine, alternator, etc. The current-based control may be achieved with a method shown in FIG. 9. The brake system 100 may be controlled with a field-oriented control (FOC). The brake system 100 may include individual measurements of the phase currents from the motor 136. Clarke transformation (Clark) may be used for converting the measurements of the phase currents from the motor 136 to the alpha beta frame. The position sensor 138 may provide feedback of the rotational angle (θ) of the output shaft 140 or motor output 144, which is used to convert from the stationary alpha beta frame to the direct (d), quadrature (q), and zero components in the rotational reference frame (dq) using Park Transformation (Park). Each of the feedback components may be compared to a command reference and cascaded through a controller to determine the command voltage in the dq rotational frame. The controller may be a feedback control loop that calculates an error signal by taking the difference between the feedback component and the command reference or set point. The rotor position angle (θ) or output shaft 140 or motor output 144 feedback may be used to transform from the dq frame to the rotational alpha beta frame using a reverse Park Transformation (RevPark). Space vector pulse width modulation (SVPWM) may be used to calculate each of the individual phase voltages which are provided to the motor 136 from the electronic control unit 300.

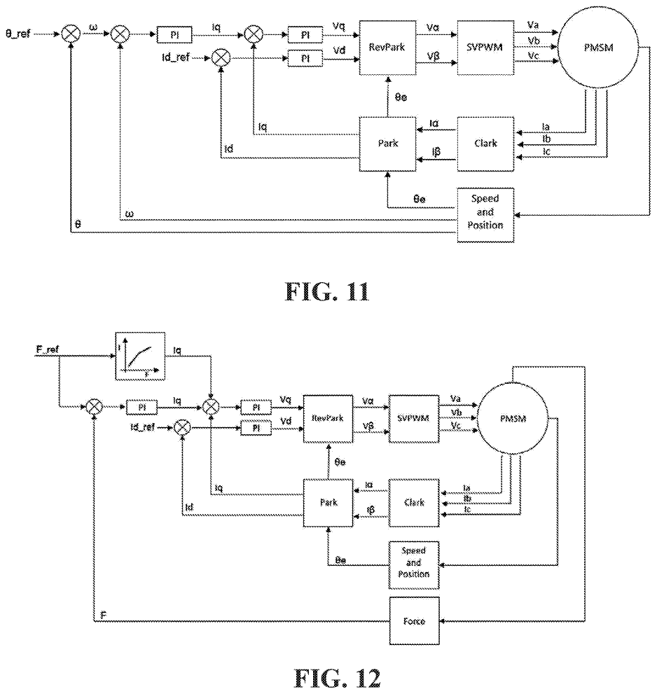

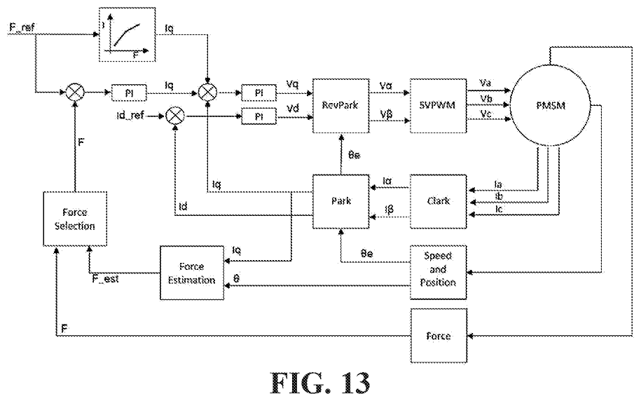

The brake system 100 may be controlled with a speed-based control of the motor 136 as shown in FIG. 10. The position sensor 138 may provide a closed loop speed feedback to the reference command. The calculated error may be provided to a controller for calculation of the quadrature current which is cascaded with the speed controller. Correspondingly, a position-based control may be achieved by adding the additional positional reference cascaded with the speed control as shown in FIG. 11. In both cases, field weakening may be implemented by means of commanding a non-zero Id reference in case that an increased speed/position response is required. Implementation is typically achieved by means of theoretical or experimental lookup of Id_ref.

The brake system 100 may be controlled with a forced-based control of the motor 136. Closed loop force control may be achieved by means of the force sensor transducer 141. Force measurements are compared to command for quadrature current correction. Such correction may provide for disturbance correction within a brake apply (parking or service), for example brake torque variation due to DTV or actuator degradation. A feedforward component can be provided based on the actuator dynamics as force has a direct relationship to both MGU torque and correspondingly quadrature current. Due to back driving effect of the rotary to linear stage mechanism 126, it may be required to have a feedforward component to maintain a steady state load condition as feedback approaches the command target. The force transducer 141, which may be located within the caliper assembly 102, actuator 124, motor 136, etc. may include redundant measurement to provide a means of reliability judgement between the two signals. If it is determined that the force feedback is unreliable, a means of force estimation can be provided based on the measured position of the motor output or shaft and motor current per the defined actuator dynamics.

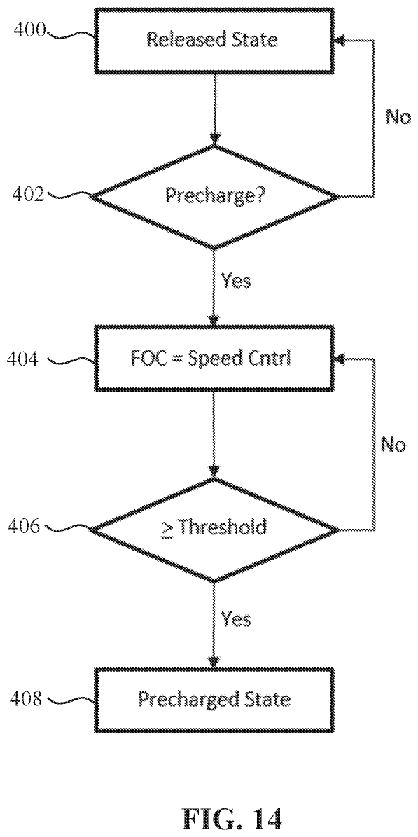

FIG. 14 illustrates method steps associated with the brake system 100 entering a pre-charge state 408. A pre-charge state 408 may mean or refer to a position of the brake system 100 where any gap defined between the nut 132 and the brake piston 118 is taken up or reduced to zero. A pre-charge state 408 may mean or refer to a position of the brake system 100 where any gap defined between the brake piston 118 and the brake pad is taken up or reduced to zero. A pre-charge state 408 may mean or refer to a position of the brake system 100 where any gap defined between the brake pad and the brake rotor is taken up or reduced to zero. A pre-charge state 408 may mean or refer to a position of the brake system 100 where a gap or clearance within a certain tolerance is defined or made to exist between the nut 132 and the brake piston 118, between the brake piston 118 and the brake pad, and/or between the brake pad and brake rotor. A pre-charge state 408 may mean or refer to a position of the brake system 100 where virtually no clamping force is generated. A pre-charge stage 408 may occur before a service brake apply, a parking brake apply, or both.

The brake system 100 may enter a pre-charge state 408 from a released state 400, where virtually no clamping force is present. In a released state 400, the one or more brake pads are not in contact with the brake rotor. In a released state 400, a gap or space is defined between the nut 132 and the brake piston 118. In other words, the nut 118 is not applying an urging or pushing force onto the brake piston 118 and the brake piston 118 is not applying an urging or pushing force onto the brake pad and thus the brake pad is not applying an urging or pushing force onto the brake rotor, and thus no clamping force is generated.

An instruction 402 may be provided to the brake system 100 to enter the pre-charge state 408 by a controller 300 associated with the brake system 100 and/or the vehicle. The request or instruction 402 may be in response to a brake intention, such as a user or operator depressing a brake pedal, the vehicle slowing down, the user pushing a button, a verbal command, the vehicle detecting an obstacle or obstruction in the path of the vehicle, etc. Upon receiving the request or instruction 402 for pre-charge, the gap between the nut 132 and the brake piston 118 is taken up or reduced to zero by operating the motor 136 to generate the torque to operate the actuator 124 to rotate the spindle 132 and thus move the nut 132 into contact with the brake piston 118. Accordingly, after receiving the request or instruction 402 for pre-charge, the gap defined between the brake pad and the brake rotor is taken up or reduced to zero. The gap between the nut 132 and the brake piston 118 and/or between the brake pad and the brake rotor may be taken up using a speed-based control 404 or a position-based control. A speed-based control 404 may be preferred over position based, because a speed-based control may achieve the pre-charge state 400 faster than a position-based control.

The brake system 100 may achieve the pre-charge state 408 after a value meets or exceeds a threshold value in step 406. The threshold value may be a time value, a force or pressure value, a current value, a position value, or a combination thereof. For example, in certain configurations, the threshold value may be a time value (if using a speed-based control), a current value (if using a current-based control), a force or pressure value (if using a force-based control), or a position value (if using a position-based control). However, in some configurations, one or more of the threshold value (time, force or pressure, current, position) may be used for any type of control (speed-based control, current-based control, force-based control, position-based control) After the value meets or exceeds the threshold value 406, the brake system 100 is in the pre-charge state 408.

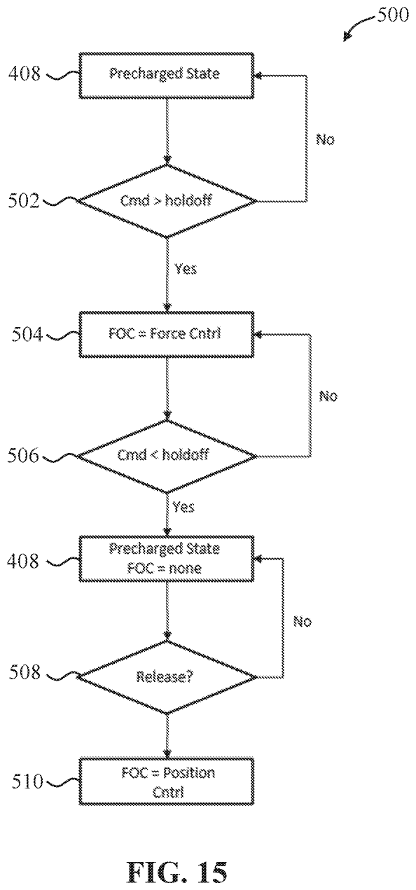

FIG. 15 illustrates the method steps 500 associated with operation of the brake system 100 during a service brake operation. Of course, one or more of these steps may also be utilized during a parking brake operation. The method in FIG. 15 begins with determining if the brake system is in the pre-charged state 408 (See FIG. 14). After the controller 300 determines that the brake system 100 is in the pre-charged stage 408, the controller 300 or brake system 100 may then check or determine if the command or instruction for clamping force is greater than or exceeds a threshold or holdoff value at step 502. If the command or instruction is greater than the hold off value 502, then then the method 500 will transition to force-based control 504 and generate the clamping force to slow, stop, or maintain the vehicle in a stopped position. Again, the clamping force is generated by the nut 132 pushing the brake piston 118 against the brake pad and the brake pad against the brake rotor.

In the event a signal or instruction 506 is sent to the controller 300, where a brake command value is less than the hold off value, for example, if a vehicle operator removes their foot from the brake pedal, then the method 500 may transition back into the pre-charge state 408 (FIG. 14) and wait in the pre-charge stage 408. Ultimately, when a release command 508 is received, for example, by a user pushing the accelerator pedal, the method 500 will transition into a position-based control 510, where the actuator 124 is moved so that a gap is defined between brake pad and the brake rotor and between the nut 132 and the brake piston 118.

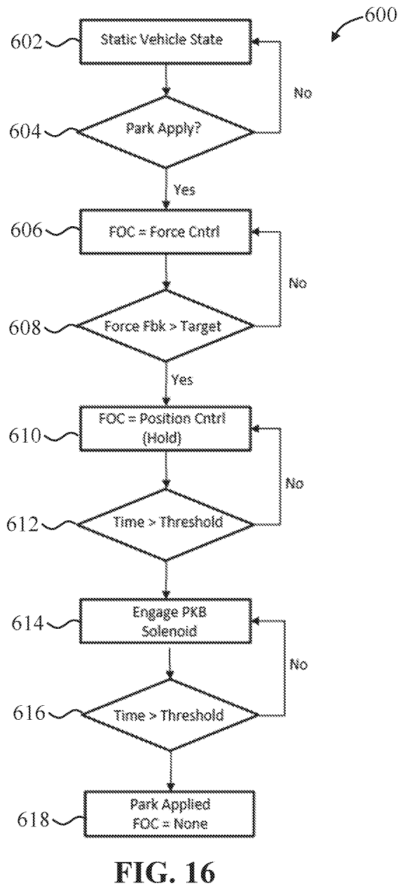

FIG. 16 illustrates a method 600 for generating a clamping force or applying the parking brake. Of course, this method may also or instead be used for applying the service brake. The parking brake may be applied at any time, as long as the vehicle is static or not moving 602. This means, the vehicle can be in a pre-charge state 408 (FIG. 14), while brake pedal is depressed, or while there is a clearance between the nut 132 and the brake piston 118 and/or between the brake pad and the brake rotor.

After a command 604 is received to apply the parking brake (for example, by a user turning the vehicle OFF, pushing a button or lever, a voice command, etc.), the method 600 may transition to a forced-based control at step 606, where the clamping force is generated until the measured force is greater than a threshold target force. This force feedback may be generated via the force sensor 141 or any other sensor in the brake system 100. After the measured force is greater or equal to a threshold target force, then the method 600 may transition to a position-based control 610 to hold the clamping force. A timer may begin at step 612 to ensure the clamping force is held for a sufficient amount of time before the locking device 146 is activated at step 614 to hold and maintain clamping force. After another timer exceeds a threshold at step 616, then the parking brake has been applied at step 618 and the FOC or motor can be disabled.

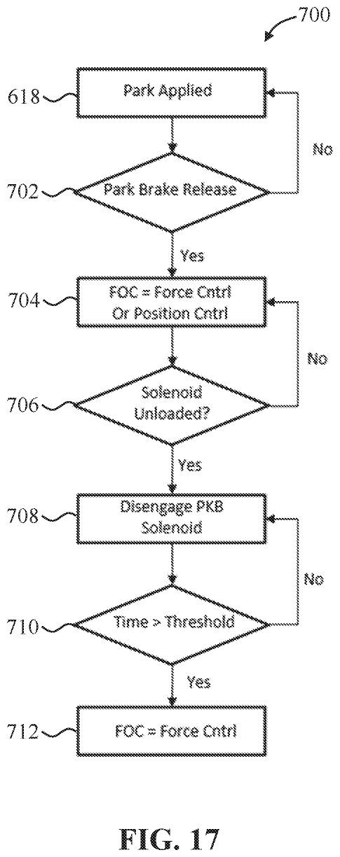

FIG. 17 illustrates the method steps 700 associated with releasing the clamping force generated in FIG. 16. The method begins with the vehicle in the parked position or clamping force generated 618 (FIG. 16). After a command or instruction 702 is received to release the clamping force (for example, by a user or operator turning the vehicle ON, pushing the accelerator pedal, pushing a button or lever, a verbal command, etc.), the method 700 may transition to a force-based control or a position-based control 704 by turning on the motor and generating additional clamping force to relieve the load on the locking device 146 to unload or unlock 706 the locking device 146. After the method 700 or controller 300 determines the locking device 146 is unloaded at 708, a timer may be set to ensure the locking device 146 is sufficiently unloaded and the method 700 may transition to a force-based control or position-based control 712 to set a gap or running clearance between the brake pad and the brake rotor. Alternatively, after the method 700 or controller 300 determines the locking device 146 is unloaded at 708, a timer may be set to ensure the locking device 146 is sufficiently unloaded and the method 700 may transition to a force-based control if the command is greater than a holdoff or threshold, a pre-charged state if command is less than the holdoff or threshold, or a released clearance state, if commanded per FIG. 15

The brake system disclosed herein may be a service brake system. The brake system disclosed herein may be a parking brake system. The brake system may be a combined service and parking brake system. The brake system may be free from using fluid or hydraulic fluid to pressurize and move the one or more brake pistons to create and/or maintain the clamping force. In some configurations, the brake system may use fluid or hydraulic fluid to pressurize and move the one or more brake pistons for one or more braking functions (i.e., for service brake and/or parking brake. In some configurations, the brake system may use fluid or hydraulic fluid to create a clamping force during one braking function (i.e., for service braking) and an electro-mechanical system for another braking function (i.e., for parking brake), or vice versa.

The brake system may be a system or assembly for creating or releasing a clamping force. The clamping force may be a force that, when coupled with a brake pad friction material coefficient of friction, functions to decelerate, slow, stop, and/or prevent movement or rotation of a brake rotor, road wheel, and/or vehicle. The clamping force may be used during a service brake operation to slow, stop, and/or maintain a vehicle in a stopped position. The clamping force may be used during a parking brake operation to maintain a vehicle in a stopped or parked position. The clamping force may be used during both a service and parking brake operation.

The clamping force creates a transfer of energy by converting the kinetic energy of the vehicle into thermal energy by frictionally engaging one or more brake pads with one or more sides of the brake rotor. The one or more brake pads may include one or more features (i.e., ears, projections, etc.) that may engage or be engaged by a brake caliper, a support bracket, or both to maintain the location of the brake pads within the brake system and relative to the brake rotor.

One or more brake systems may be incorporated into a vehicle. The vehicle may be a passenger car or truck, a heavy-duty vehicle such as a semi-truck or construction dump truck, a race car, a motorcycle, an off road vehicle, a utility vehicle, an all-terrain vehicle (ATV), a utility terrain vehicle (UTV), etc.

The brake system may include a brake caliper. The brake caliper may function to support the components of the brake system including: the one or more brake pads, the one or more brake pistons, the one or more motors, the one or more MGUs, the one or more locking devices, the one or more rotary to linear stage mechanisms, or a combination thereof. The brake system may be made of a suitable material, such as metal, iron, steel, aluminum, plastic, a composite, or a combination thereof. The brake caliper may be made via a casting process, a molding process, a milling process, or a combination thereof. The brake caliper may be made of a unitary construction. The brake caliper may be produce via two or more pieces or halves, that are subsequently joined together via one or more fasteners (bolts, screws, welding, etc.) The brake system may include one or more brake pads. One or more of the brake pads disclosed herein may be arranged on the inboard side of the brake rotor and one or more of the brake pads may be arranged on the outboard side of the brake rotor. The brake pads may be supported on or by the brake caliper. The brake pads may be supported on or by the support bracket that is connected to the brake caliper.

A brake pad may have a pressure plate and a friction material. The friction material may be moved against a side of the brake rotor to create friction to create the clamping force. During a brake apply (service and/or parking), the pressure plate may be pushed by one or more brake pistons and/or pulled by one or more fingers or the bridge of the caliper until the friction material is pressed against the brake rotor.

The brake system may have one or more brake pistons. The one or more brake pistons may be arranged on one side of the brake rotor (inboard side or outboard side of the brake rotor). The one or more brake pistons may be arranged on both sides of the brake rotor. A brake piston may have a hollow portion or pocket that may function to receive at least a portion of a corresponding rotary to linear stage mechanism. The brake piston pocket may be a cup or recess formed into an end of a brake piston. The brake piston pocket may include a bottom wall at the end or bottom of the brake piston pocket and an opposing open end. A clearance gap may exist between the nut of the rotary to linear stage mechanism and a corresponding bottom wall. During a brake apply (service and/or parking), the clearance gap may be taken up by moving the nut of the rotary to linear stage mechanism towards the bottom wall. The nut may be moved by rotating the spindle with an actuator. Once the gap is taken up, further movement of the nut or rotary to linear stage mechanism may cause the nut or the rotary to linear stage mechanism to press against the bottom wall of the brake piston and then move the brake piston and thus brake pad against the brake rotor to create the clamping force.

By moving the nut away from the bottom pocket wall, the brake piston may move in an opposite, release direction, so that the brake pad can then move away from the brake rotor to release the clamping force. The brake piston may be pulled back by the rotary to linear stage mechanism. The brake piston may roll back due to the elastic properties of one or more piston seals surrounding the brake piston.

The brake system may include one or more motors. The motor may be any motor for creating a force or torque. For example, the motor may be a permanent magnet synchronous motor (PMSM), or an electric excited synchronous motor (EESM). The motor may include one or more electrical leads, terminals, connections, or plugs for connecting the motor to a power source, computer, processor, and/or electronic control unit. Supplying power to the motor may cause the output shaft of the motor or output gear to rotate about an axis. The output shaft rotation may be adapted for an apply direction (to create a clamping force) and for a release direction (to release a clamping force). The apply direction may be clockwise and the release direction may be counter clock wise, or vice versa. The motor may be part of the actuator. The motor may be a separate component of the actuator. The motor may be contained in the housing with the actuator. The motor may be contained in a separate housing as the actuator.

The brake system may comprise one or more rotary to linear mechanisms. The rotary to linear stage mechanism may function to convert a torque output from a power source into a linear or axial force to move the one or more brake pistons. The power source may be one or more motors and/or the actuator. The rotary to linear stage mechanism may be a high-efficiency device such as a ball screw, a roller screw, a ball ramp, a ball nut assembly, a ball screw assembly. The rotary to linear stage mechanism may be a low-efficiency device, such as a lead screw, which has higher friction between the spindle and nut compared to a high efficiency device.

The spindle may be rotated by the motor and/or the actuator and/or by one or more gears. The spindle may be rotated in an apply direction and a release direction to apply and release the brake system, respectively. Rotation of the spindle may cause a nut, which is threadably engaged with the spindle, to move axially along a longitudinal axis of the spindle in an apply or release direction to move the brake pad towards or away from a brake rotor. The spindle may be driven directly by a motor or gear (direct connection or attachment between the two elements). The spindle may be driven indirectly by the motor or gear (indirect connection or attachment between the two elements, meaning one or more gears, shafts, belts, chains, or other intermediate connection members are provided between the spindle and the motor or gear).

The nut may be moved axially along an axis that the spindle is configured to rotate about. For example, the nut and the spindle may be threadably engaged such that when the spindle is rotated by the motor or driving gear, the nut moves axially toward or away from a wall of the piston pocket. After contact between the nut and the piston pocket wall is made, further movement of the nut may result in movement of a brake piston and thus a brake pad, or a corresponding end of a brake pad towards a brake pad. The nut may be restricted or prevented from rotating about the axis along which it is configured to axially move. That is, the nut may have a suitable anti-rotation feature that prevents the nut from rotating about the axis that the spindle rotates about.

If the rotary to linear stage mechanism comprises a ball screw, then the rotary to linear stage mechanism may have a plurality of balls between the spindle and nut. The balls are contained in matching helical grooves of the spindle and nut and the balls roll between the grooves to provide the only contact between the spindle and the nut. In some configurations, the rotary to linear stage mechanism may be free of any balls between the spindle and the nut.

The rotary to linear stage mechanism may be part of the actuator. The rotary to linear stage mechanism may be located downstream of the actuator. The rotary to linear stage mechanism may be located in the housing and assembled into the brake caliper. The rotary to linear stage mechanism may be installed in the brake caliper and then the actuator may be installed or attached to the caliper and connected to the rotary to linear stage mechanism.

The brake system may comprise one or more locking devices. The locking device may function to lock or maintain the clamping force after the clamping force is created. The locking device may function to restrict or prevent the motor, the rotary to linear stage mechanism, the spindle, the nut, the brake piston, and/or the brake pad from moving. The locking device may function to restrict or prevent the motor, the rotary to linear stage mechanism, the spindle, the nut, the brake piston, and/or the brake pad from back driving after a clamping force has been created. The locking device may function to maintain a rotary or linear position of the motor, the rotary to linear stage mechanism, the spindle, the nut, the brake piston, and/or the brake pad. The locking device may function to maintain the clamping force. The locking device may function to maintain the clamping force during a re-clamp operation, where the clamping force is adjusted or increased. The locking device may function to maintain the clamping force even after the motor has been disconnected or disengaged or is no longer generating torque.

The locking device may be disengaged to allow release of the clamping force. The locking device may be disengaged to lower the amount of clamping force that was created during a brake apply.

The locking device may be engaged during only a service brake apply, only during a parking brake, or during both a service and parking brake apply.

The locking device may comprise one or more solenoids. The one or more solenoids may include a bi-stable solenoid, a linear solenoid, a rotary solenoid, a DC solenoid (C or D frame), or the like.

A bistable solenoid may include one or more electromechanical magnets with a linear direction of motion in which a plunger or moveable member is locked into each end position. This may be achieved by equally dividing the coil more or less in the center and by using the resulting gap as a permanent magnet. Bistable Rotary Solenoids can be driven to rotate in either direction and hold in either end position with no power applied.

The locking device may comprise a dog clutch. The dog clutch may include a clutch or engaging member and a dog or mating member. Each of the clutch and dog may include an engaging male/female profile, such as teeth that engage valleys defined between teeth. The teeth may have a sloped or canted wall and an opposing generally vertical wall, that allows the mating member to rotate relative to a fixed engaging member, or vice versa.

The clutch or engaging member may be a piston or plunger or connected to a piston or plunger that moves axially to engage or disengage the locking member. The piston or plunger or engaging member may axially move to engage the dog or mating member by reacting to a magnetic field created by the solenoid when current is supplied to the solenoid and not supplied to the solenoid. The clutch or engaging member may be restricted or prevented from rotating. However, in some configurations, the clutch or engaging member may be configured to rotate. The dog or mating member may be configured to rotate. The dog or mating member is restricted or prevented from axially moving along the axis that it rotates. However, in some configurations, the mating member may axially move along an axis.

The locking device may be part of the actuator. The locking device may be located downstream or upstream of the actuator. The locking device may be located in the housing and assembled into the brake caliper. The locking device may be located outside or external of the housing.

The locking device may be of the type disclosed in commonly owned U.S. Pat. No. 11,136,010 B2, filed as U.S. Ser. No. 16/269,718 on Feb. 7, 2019, which claims priority to U.S. 62/632,457, filed on Feb. 20, 2018, all of which are expressly incorporated by reference herein for all purposes.

The brake system may include one or more force sensors. The force sensor may function to convert a physical force into one or more electrical signals. The force senor may be a load cell. The force sensor may be a sensor that converts an input mechanical load, weight, tension, compression or pressure into an electrical output signal. The electrical output signal may be provided to the electronic control unit for use with the method disclosed herein. The electrical output signal may be used to determine the amount of clamping force generated during or after a brake apply. The force sensor may measure the amount of force acting on the brake pad (via the brake piston), the amount of force acting on the brake piston (via the nut), or a combination thereof. The force sensor may measure a reduction of force to generate the output signal. For example, when the nut is in a retracted position, a force may be applied on the force sensor. When the nut is moved towards the piston and pushing the piston during a brake apply, the force acting on the force sensor may be reduced, which may be correlated to a clamp force being generated.

The electronic control unit may function to control the brake system. The electronic control unit may be part of the brake system or part of the vehicle. Each brake system may have its own control unit (i.e., front left wheel, front right wheel, rear left wheel, rear right wheel, etc.) or one electronic control unit may control two or more brake systems (front and rear or left and right). The control unit may be part of the vehicle controller. The control unit may comprise a processor, memory, a program. The control unit may be programmable and reprogrammable. The control unit may control the motor and the locking device, together or individually. The control device may operate the locking device only during certain brake operations, such as while parking on a hill or incline. In other instances, the control device may operate the locking device during or after all braking events (service and/or parking brake) The brake system according to these teachings may comprise one or more gears. Any gear disclosed herein may be replaced by two or more gears. Any two or more gears disclosed herein may be replaced by a single gear. One or more intermediate gears may be provided between any two or more gears disclosed herein as directly meshingly engaging one another. Any intermediate disclosed herein between two or more other gears may be eliminated.

One or more of the gears may be part of the actuator, separate from the actuator, contained in the housing, located outside of the housing or combination thereof.

Any gear disclosed herein may be a spur gear, helical gear, bevel gear, worm gear. Any gear disclosed herein may be replaced by a spur gear, helical gear, bevel gear, worm gear.

While the gears disclosed herein are described as having teeth that mesh with or meshingly engage other teeth gears to transmit torque between the gears, it is understood that other means can be used to transmit torque such as, for example, using one or more belts, chains, intermediate gears, shafts, rack and pinions, axles, etc. Moreover, in certain applications, the teeth on one or more of the gears may be eliminated and the gears may engage one another via a pressure or friction fit to transmit torque. Furthermore, any gear disclosed herein may be replaced with a shaft, belt, chain, or other torque transmitting means. Furthermore, any of the gears and their orientation disclosed herein may be rearranged and still be within the scope of this disclosure.

The gears disclosed herein may be made of any material, such as metal, plastic, 3D printed, etc. The one or more gears may be made via a casting or plastic injection molding process.

Any of the gears, elements, or assemblies disclosed herein may be rearranged such that a previously disclosed element extending or moving along or rotating about an axis A, B, or C may extend along or rotate or move along another axis that is parallel or not parallel (i.e., perpendicular or at another angle) to any axis A, B, C.

One or more bearings and/or bushings may be provided at any interface where one or more gears are described as rotating about a shaft or axis.

Various embodiments are disclosed herein. It is within the scope of this disclosure that the elements of the embodiments may be combined, duplicated, or separated into additional embodiments. Also, any element disclosed herein may be eliminated from any of the assemblies disclosed herein, duplicated, and/or combined with other elements.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1) A brake system comprising:
a brake caliper;
a brake piston supported by the brake caliper;
a brake pad supported by the brake caliper or by a support bracket associated with the brake caliper;
a rotary to linear stage mechanism connected to the brake piston;
a motor configured to drive the rotary to linear stage mechanism to move the brake piston and the brake pad against a brake rotor to generate a clamping force; and
a locking device configured to maintain a position of the rotary to linear stage mechanism after the clamping force has been created, wherein the locking device comprises a bistable solenoid,
wherein the motor is supported on the brake caliper and located on one side of the rotary to linear stage mechanism and the locking device is located on another side of the rotary to linear stage mechanism.

2) The brake system according to claim 1, wherein the locking device comprises a dog clutch.

3) The brake system according to claim 2, wherein the dog clutch comprises an engaging member, the engaging member is restricted from rotating about an axis but is configured to move along the axis.

4) The brake system according to claim 3, wherein the dog clutch comprises a mating member, wherein the mating member is configured to rotate about the axis but is restricted from moving along the axis.

5) The brake system according to claim 3, wherein the engaging member is moveable between an unlocked position and a locked position, wherein in the locked position the engaging member is engaged with the mating member, and in the unlocked position, the mating member is configured to rotate about the axis.

6) The brake system according to claim 5, wherein the engaging member and the mating member comprise teeth, and one or more of the teeth are canted.

7) The brake system according to claim 8, wherein the rotary to linear stage mechanism is located on an inboard side of the brake rotor.

8) The brake system according to claim 1, wherein the brake system comprises a plurality of gears between the motor and the rotary to linear stage mechanism, wherein the one plurality of gears are arranged in a planetary gear system.

9) The brake system according to claim 1, wherein the motor has an output that rotates about an axis, the locking device has an output that rotates about an axis, and the spindle rotates about an axis, wherein all axes are generally parallel to one another.

10) The brake system according to claim 9, wherein a space defined between the axis of the motor output and the axis that the spindle rotates about is generally the same as a space defined between the axis that the spindle rotates about and the axis that the output of the locking device rotates about.

11) The brake system according to claim 6, wherein the brake system is a floating caliper.

12) The brake system according to claim 11, wherein the motor and/or the locking device are contained in a housing, that is separable from the brake caliper.

13) The brake system according to claim 12, wherein the brake system comprises a plurality of gears between the motor and the rotary to linear stage mechanism, wherein one of the plurality of gears are arranged in a planetary gear system and in the housing.

14) A method of operating the brake system according to claim 1, wherein the method comprises:
a) generating the clamping force by moving the brake pad against the brake rotor using the motor and the rotary to liner stage mechanism; and
b) engaging the locking device to maintain the position of the rotary to linear stage mechanism after the clamping force has been created;
wherein the brake system is controlled using a field-oriented control.

15) The method according to claim 14, wherein the method comprises a step of entering a pre-charge state, where a gap between a nut and the brake piston is eliminated or optimized for reduced free running time.

16) The method according to claim 15, wherein the method comprises using a speed-based control to achieve the pre-charge state and then using a force-based control to generate the clamping force.

17) The method according to claim 14, wherein the method comprises unloading the bistable solenoid to release the clamping force by increasing the clamping force.

18) The method according to claim 17, wherein the method comprises using a position-based control to set a clearance between the brake pad and the brake rotor.

19) The method according to claim 14, wherein the method is free of any steps of pressurizing hydraulic fluid to generate the clamping force.

20) The method according to claim 14, wherein the method utilizes a current based control.
